(19) United States
(12) Patent Application Publication
(10) Pub. No.: US 2008/0297143 A1
(43) Pub. Date: Dec. 4, 2008

(54) Magnetic Encoder and Wheel Bearing Provided with the Same

(76) Inventors: Toshihiko Tanaka, Aichi-ken (JP); Tatsuo Nakajima, Shizuoka-ken (JP)

Correspondence Address: WENDEROTH, LIND & PONACK, L.L.P., 2033 K STREET N. W., SUITE 800, WASHINGTON, DC, 20006-1021, US

(21) Appl. No.: 11/793,012

(22) PCT Filed: Jan. 10, 2006
(86) PCT No.: PCT/JP06/00134

§ 371 Date: Feb. 27, 2008

(30) Foreign Application Priority Data
Jan. 11, 2005 (JP) 2005-004467

(51) Int. Cl. G01P 3/487; F16C 41/00

(52) U.S. Cl. 324/173; 384/624

(57) ABSTRACT

The density of a multipolar magnet in this type of magnetic encoder, in particular, a multipolar magnet composed of a sintered compact, is made uniform.

Samarium-iron based magnetic powder is used as magnetic powder, tin powder is used as non-magnetic metal powder, and a compressed molded body 114 is obtained by compression molding of a mixed powder of 20 to 90 wt % of samarium-iron based magnetic powder and 10 to 80 wt % of tin powder. The compressed molded body 114 is sintered at a temperature less than the melting point of the tin powder serving as the non-magnetic metal powder, so that the sintered compact is formed which serves as the multipolar magnet of the magnetic encoder 10.

### TECHNICAL FIELD

The present invention relates to a magnetic encoder and a wheel bearing provided with the same, and is used in rotation detectors for detecting the rotational speed of a wheel in, for example, antilock brake systems for automobiles.

### BACKGROUND ART

There are generally two types of such rotation detectors; a passive type that reads the movement of concavo-convex tooth formed on a rotor as magnetic variation, and an active type that reads magnetic strength variation depending on the rotation of a magnetic encoder with a magnetic sensor such as a hall IC are used.

General active-type rotation detectors include a magnetic encoder mounted on a member located in the rotor side of a wheel bearing, and a magnetic sensor mounted on a member located in the stator side.

A magnetic encoder is composed of, for example, a ring multipolar magnet in which N and S poles are alternatively magnetized in the circumference direction, and a base metal for securing the multipolar magnet to the rotor-side member. A multipolar magnet made of an elastomer to which magnetic powder is added is known (refer to Patent Document 1: Japanese Patent Laid-Open Publication No. Hei 6-281018, for example). On the other hand, there is known, as a recent multipolar magnet, a sintered compact in which a mixture of magnetic powder and non-magnetic metal powder is subjected to compression molding and sintered (refer to Patent Document 2: Japanese Patent Laid-Open Publication No. 2004-37441, for example).

### DISCLOSURE OF INVENTION

While the multipolar magnet consisting of the sintered compact has an advantage of high abrasion resistance and low processing cost compared with the elastomer-type multipolar magnet, and thus is highly preferable as a product, it has a problem in which it is difficult to make the density of the sintered compact uniform all over.

The mixture of the magnetic powder and non-magnetic metal powder is compressed and formed into a predetermined shape, and then sintered. In general, as the non-magnetic metal powder, powder having a melting point lower than that of the magnetic powder is used, and heating the mixture to a temperature of the melting point of the non-magnetic metal powder or higher temperatures melts the non-magnetic metal powder and thus makes the non-magnetic metal powder act as a binder. However, their combination, for example, in which wettability of the non-magnetic metal powder to be used onto the magnetic powder is not good, is often difficult to make the non-magnetic metal in melting state stay in the surface of magnetic powder particles, may place the non-magnetic metal in a state that is unevenly distributed in the inside of the sintered compact, and, in some cases, causes the non-magnetic metal to flow out to the surface of the sintered compact. Therefore, the density of the sintered compact becomes uneven and thus may not provide a desired mechanical strength.

A problem to be solved by the present invention is to improve uniformity of density of the multipolar magnet, specifically consisting of a sintered compact, in such magnetic encoders.

In order to solve the problem, a magnetic encoder according to the present invention comprises a multipolar magnet prepared by subjecting a mixed powder of magnetic powder and non-magnetic metal powder to compression molding and then be sintered, and the magnetic encoder is characterized in that the multipolar magnet is composed of 20 to 90 wt % of the magnetic powder and 10 to 80 wt % of the non-magnetic metal powder, and is sintered at a temperature less than the melting point of the non-magnetic metal powder.

As such, sintering the mixed powder at the temperature less than the melting point of the non-magnetic metal powder softens the non-magnetic metal powder without melting and secures the non-magnetic metal powder to the magnetic powder. The non-magnetic metal powder in a state that is secured to the magnetic powder acts as a binder between the magnetic powders. Even if the non-magnetic metal powder is partially in a fluid state, the non-magnetic metal powder stays in the surface of the magnetic powder particles because the fluidity is low. Therefore, the non-magnetic metal powder neither is unevenly distributed in the sintered compact nor flows to the surface side, so that the sintered compact in which the magnetic powder and the non-magnetic metal powder are uniformly distributed all over is obtained. In addition to this, in this structure, the multipolar magnet is preferably composed of 20 to 90 wt % of the magnetic powder and 10 to 90 wt % of the non-magnetic metal powder, and more preferably 40 to 80 wt % of the magnetic powder and 20 to 60 wt % of the non-magnetic metal powder. This is because the non-magnetic metal powder the mixture ratio of which is less than 10 wt % does not act as a binder well, and the magnetic powder the mixture ratio of which is less than 20 wt % has an insufficient magnetism, thereby reducing sensing performance of the magnetic sensor.

The non-magnetic metal powder preferably has a maximum grain size of 63 μm or less. Such fine powder causes the non-magnetic metal powder to be uniformly distributed around the magnetic powder. Accordingly, it is possible to make the density of the sintered compact more uniform. Furthermore, the small-sized powder makes the apparent density of the powder low. Accordingly, the compression rate (compression stroke) at compression molding can be set to a large value with no change in dimensions and weight of the molded article. As a result, the non-magnetic metal powders or the non-magnetic metal powder and magnetic powder can be well intertwined with each other (the contact area can be increased), thereby increasing the strength of the molded article.

In view of intertwining powders at compression molding, non-spherical particles, such as spongy, acicular, angular, dendritic, fibrous, flake, irregular, and teardrop particles, are preferably used as the non-magnetic metal powder. This allows the powders to well intertwine, thereby providing more strength. Furthermore, such a non-spherical non-magnetic metal powder can be molded by, for example, a water atomization method or an oil atomization method.

As the magnetic powder constituting the sintered compact, for example, samarium-iron based magnetic powder is preferably used, and as the non-magnetic metal powder, for example, tin or a tin-zinc alloy is preferably used. When the tin-zinc alloy is used, the mixture ratios of tin and zinc are preferably determined so that tin is contained in an amount of 60 to 85 wt % and zinc is contained in an amount of 15 to 40 wt %. This makes the apparent density of the mixed powder much lower, thereby providing more strength.

The magnetic encoder provided with the multipolar magnet having the configuration described above is usable for, for example, a wheel bearing.

As described above, the present invention can make the density of the multipolar magnet in this type of magnetic encoder uniform. Therefore, it is possible to obtain a sintered compact with much higher strength, and to provide the magnetic encoder which allows easy handling at manufacturing and assembling and provides excellent productivity.

### BRIEF DESCRIPTION OF THE DRAWINGS

FIG. 1 is a partial perspective view of a magnetic encoder according to an embodiment of the present invention;

FIG. 2 is a front view of the magnetic encoder, illustrating an array of magnetic poles;

FIG. 3 is a partial perspective view showing an example of a method for sintering and securing a compressed molded body to a base metal;

FIG. 4 is a cross sectional view of a seal device with the magnetic encoder, and a magnetic sensor;

FIG. 5 is a partial perspective view showing another example of a method for sintering and securing the compressed molded body to the base metal;

FIG. 6 is a partial perspective view showing another example of a method for sintering and securing the compressed molded body to the base metal;

FIG. 7 is a partial perspective view showing another example of a method for sintering and securing the compressed molded body to the base metal;

FIG. 8 is a cross sectional view showing a structural example of a wheel bearing provided with the magnetic encoder;

FIG. 9 is an enlarged cross sectional view of the surrounding of the magnetic encoder of the wheel bearing;

FIG. 10 is an enlarged cross sectional view of another structural example of the magnetic encoder in the wheel bearing;

FIG. 11A shows a microphotograph of tin powder formed by the gas atomization method;

FIG. 11B shows a microphotograph of tin powder formed by the water atomization method;

FIG. 12 shows a microphotograph of the inside of the sintered compact when tin-zinc alloy powder is used as non-magnetic metal powder; and

FIG. 13 shows a result of press-fit test for the inner ring of a bearing of the magnetic encoder.

### BEST MODE FOR CARRYING OUT THE INVENTION

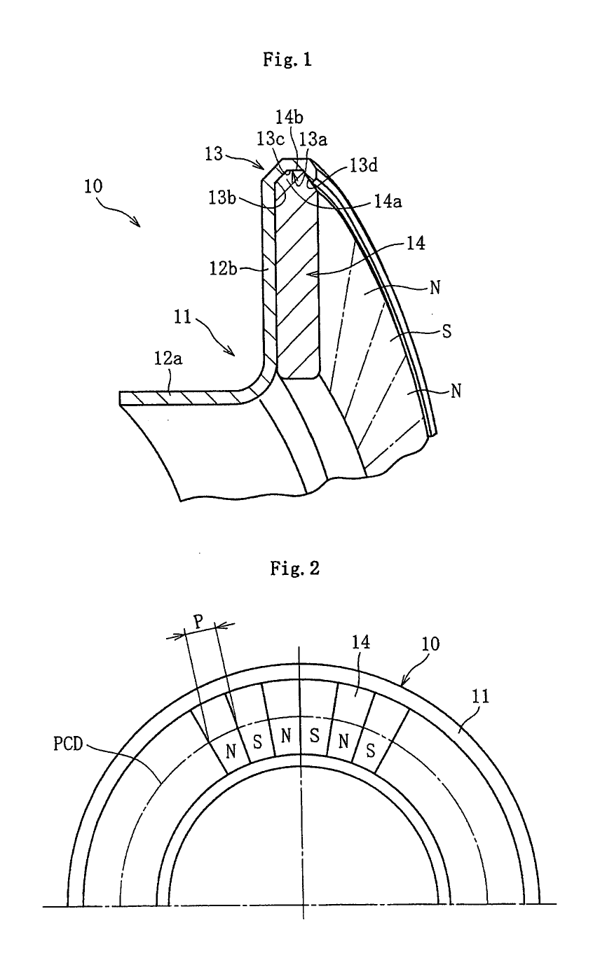

One embodiment of the present invention will now be described below on the basis of FIGS. 1 to 4.

As shown in FIG. 1, the magnetic encoder 10 comprises a ring base metal 11, and a multipolar magnet which is provided on the surface of the base metal 11 in a circumferential direction thereof. The multipolar magnet 14 is disc-shaped, and magnetized in multiple poles in the circumferential direction so that magnetic poles N and S are alternately formed. The magnetic poles N and S are formed, for example, at predetermined pitches p on a pitch circle diameter PCD, as shown in FIG. 2.

The multipolar magnet 14 is composed of magnetic powder and non-magnetic metal powder. As the magnetic powder, for example, isotropic or anisotropic ferrite powder such as barium based ferrite powder and strontium based ferrite powder, and rare earth magnetic powder such as samarium-iron based magnetic powder, neodymium-iron based magnetic powder, and manganese-aluminum gas atomized powder, can be used. In this embodiment, of the above magnetic powders, particularly, samarium-iron based magnetic powder, which is ferromagnetic, is used.

As the non-magnetic metal powder, for example, metal powder such as tin, copper, aluminum, nickel, zinc, tungsten, and manganese, mixed powder of two or more of them, or alloy powder of two or more of them can be used. In this embodiment, of the above non-magnetic metal powders, tin powder, which has a relatively low melting point, is used.

As the non-magnetic metal powder, powder with a maximum grain size of 63 μm or less is preferably used. In this embodiment, tin powder with a maximum grain size of 45 μm is used.

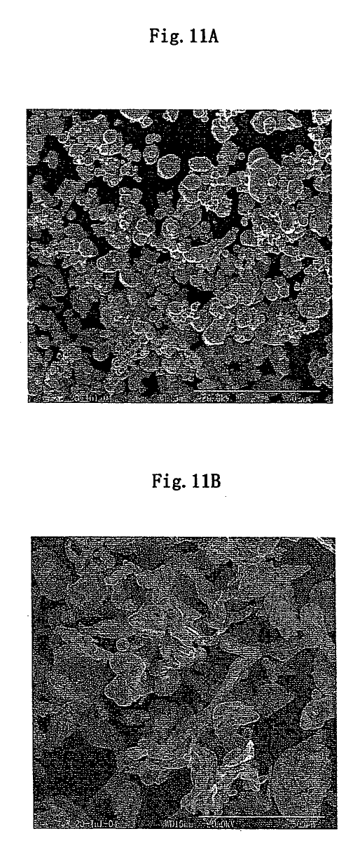

As the tin powder serving as the non-magnetic metal powder, non-spherical particles, such as spongy, acicular, angular, dendritic, fibrous, flake, irregular, and teardrop particles, are preferably used. The tin powder with such a shape can be formed by, for example, a water atomization method. The water atomization method is a method in which molten metal is naturally dropped from a pore to form a small stream of molten metal and then is blasted by a high pressure water jet to be pulverized, and has a cooldown time shorter than that of the gas atomization method. Accordingly, the cooled and pulverized tin powder has a relatively non-spherical shape. As one example, FIG. 11A shows a microphotograph of the tin powder formed by the gas atomization method, and FIG. 11B shows a microphotograph of the tin powder formed by the water atomization method. As seen from these figures, while the tin powder formed by the gas atomization method has a relatively spherical shape, the tin powder formed by the water atomization method has a relatively irregular shape. The powder having a non-spherical shape such as irregular shape can be obtained by, for example, an oil atomization method as well.

As the mixture ratio of the mixed powder of which the multipolar magnet 14 is formed, it is preferable that 20 to 90 wt % of the magnetic powder and 10 to 80 wt % of the non-magnetic metal powder be contained, and more preferable that 40 to 80 wt % of the magnetic powder and 20 to 60 wt % of the non-magnetic metal powder be contained. The non-magnetic metal powder the mixture ratio of which is less than 10 wt % does not function as a binder for the magnetic powder, so that the multipolar magnet 14 obtained after sintering is hard but brittle. This multipolar magnet 14, therefore, may be cracked when secured to the base metal 11. On the other hand, the magnetic powder the mixture ratio of which is less than 20 wt % cannot provide a large magnetic strength to the multipolar magnet 14 obtained after sintering, so that the magnetic encoder 10 may not ensure a sufficient magnetism to have a desired stable sensing performance.

The compression molding ability of the mixed powder of the magnetic powder and the non-magnetic metal powder may be improved by, for example, addition of lubricant (for example, 1 wt % or less) such as zinc stearate.

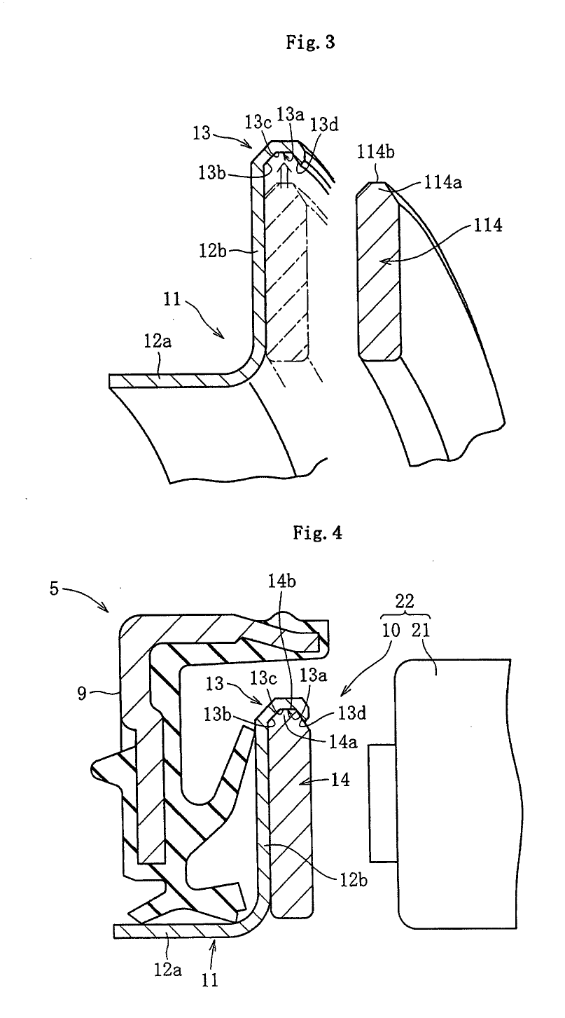

The mixed powder having the configuration described above is subjected to compression molding under a predetermined pressure to form a compressed molded body 114 having, for example, a disc shape as shown in FIG. 3. The pressure at compression molding is preferably 6.0×10³ kgfcm² or more. The compressed molded body 114 after compression molding preferably has 5 to 30 vol % pores thereinside. The porous ratio is more preferably 12 to 22 vol %, furthermore preferably 14 to 19 vol %. This is because the compressed molded body 114 with 5 vol % or less pores may be broken by spring back caused when the molding pressure is released. Moreover, this is because the compressed molded body 114 with more than 30 vol % pores provides an insufficient mechanical strength of the sintered compact and thus may be cracked when secured to the base metal 11.

It is desirable that the compressed molded body 114 have a thickness as thin as possible because the magnetic powder and non-magnetic metal powder are expensive. In view of compression molding ability and handling ability (including carrying for assembling on the base metal 11 and the like), the thickness is preferably 0.3 mm to 5 mm, and more preferably 0.6 mm to 3 mm. The compressed molded product 114 having a thickness of less than 0.3 mm is difficult to fill a mold with the powder, and thus hard to mold the compressed molded body 114. Furthermore, the compressed molded body 114 obtained in such a manner is not preferable because it may be broken at handling. On the other hand, the compressed molded body 114 having a thickness of more than 10 mm allows improved handling ability but causes increased cost. The compressed molded body 114 which is too thick is easy to make the density of the compressed molded body 114 uneven, so that irregular distortion may be caused after sintering.

The disc-like sintered compact as shown in FIG. 1 is obtained by heating and sintering the compressed molded body 114 obtained as described above in a furnace. In this instance, if the heating temperature in the furnace is set to a temperature less than the melting point of the non-magnetic metal powder, the non-magnetic metal powder is softened without melting and secured to the magnetic powder. The non-magnetic metal powder in a state that is secured to the magnetic powder acts as a binder between adjacent magnetic powders. Even if the non-magnetic metal powder is partially in a fluid state, the non-magnetic metal powder stays in the surface of the magnetic powder particles because of its low fluidity. Accordingly, the non-magnetic metal powder neither is unevenly distributed in the sintered compact nor flows to the outer surface, so that the sintered compact in which the magnetic powder and the non-magnetic metal powder are uniformly distributed all over is obtained. Therefore, the sintered compact (multipolar magnet 14) with high strength can be obtained.

As in this embodiment, when samarium-iron based magnetic powder is used as the magnetic powder and tin powder is used as the non-magnetic metal powder, the temperature at sintering is preferably set to a temperature less than the melting point (232° C.) of tin, and specifically, set to a range of 200 to 225° C. This temperature range allows the non-magnetic metal powder to sufficiently function as a binder for the magnetic powder, so that the sintered compact with high strength can be obtained.

In this embodiment, since the non-magnetic metal powder (tin powder) with a maximum grain size of 63 μm or less is used, the mixed powder in which the small-sized non-magnetic metal powder is uniformly distributed around the magnetic powder is obtained. Therefore, the sintered compact can be obtained by compression molding this mixed powder and sintering it with its density being uniform. Furthermore, since the small-sized non-magnetic metal powder has the low apparent density, the compression ratio becomes high when a compressed molded body is formed with the same dimensions and the same density. Accordingly, the powders can be well intertwined with each other, thereby increasing the strength of the sintered compact much more.

In this embodiment, in particular, since tin powder with an irregular shape (refer to FIG. 11B) is used as the non-magnetic metal powder, the compressed molded body in which powders are well intertwined with each other is obtained. Accordingly, it is possible to increase the strength of the sintered compact much more.

As described above, increasing the strength of the sintered compact improves the handling ability of the sintered compact and makes it easy to decide conditions for calking to secure the sintered compact to the base metal 11. Furthermore, when the magnetic encoder 10 which is assembled on a rotor side member described later is secured by press fit of the base metal 11 onto the rotor side member, the base metal 11 changes in shape during the press fit, so that the magnetized sintered compact (multipolar magnet 14) becomes difficult to crack. Accordingly, a large interference for press fit can be provided. Furthermore, a thin disc-like sintered compact can be formed, thereby reducing the material cost.

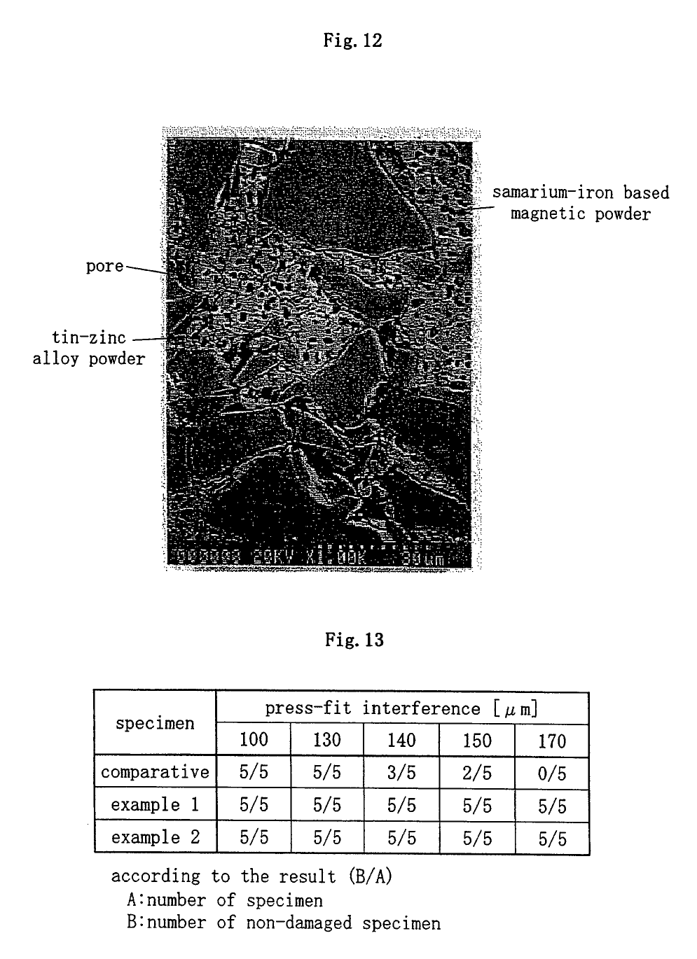

Note that the action described above can be provided not only in the case of using the tin powder but also in the case of using another non-magnetic metal powder. As one preferred example, for example, a tin-zinc alloy can be used. In this case, the mixture ratios of tin and zinc are preferably determined so that tin is contained in an amount of 60 to 85 wt % and zinc is contained in an amount of 15 to 40 wt %. The sintering temperature is preferably set to a temperature less than the melting point (about 250° C. at the above mixture ratios) of the tin-zinc alloy powder, and specifically, set to a range of 170 to 190° C. The tin-zinc alloy powder with the above mixture ratios is softened to the extent of functioning as a binder for the magnet powder even if the sintering temperature is about 170 to 190° C. Therefore, the strength of the sintered compact can be increased, and magnetic deterioration caused by increased temperatures of the magnetic powder can be suppressed as much as possible by making the sintering temperature low. FIG. 12 shows, as an example, a microphotograph of the inside of the sintered compact when the tin-zinc alloy powder is used.

Furthermore, the tin-zinc alloy powder having the structure described above, which has an apparent density lower than that of the tin powder with the same size, can make the compression ratio much larger, thereby increasing the strength of the sintered compact more. As the size of the alloy powder, powder with a maximum grain size of 63 μm or less is preferably used. In order to well intertwine the powders, tin-zinc alloy powder formed in a non-spherical shape by, for example, the water atomization method or the oil atomization method, is preferably used; this is the same as the tin powder.

The sintered compact may be secured to the base metal 11 by, for example, caulking, press fit, or adhering of the base metal 11, or may be secured to the base metal 11 by taking advantage of expansion of the sintered compact (compressed molded body 114) after sintering, as another example. In this embodiment, a method that secures the compressed molded body 114 to the base metal 11 by taking advantage of expansion of the compressed molded body 114 after sintering will be described.

The base metal 11 is configured to include a cylindrical attachment portion 12a which is secured to the rotor side member by press fit and the like, a contact portion 12b which extends from one end of the attachment portion 12a to the circumference side and comes in contact with a disc end surface of the sintered compact (multipolar magnet 14), and a securing portion 13 which is located at the circumference end of the contact portion 12b in the opposite side of the attachment portion 12a to hold and secure the multipolar magnet 14, for example as shown in FIG. 3. The securing portion 13 has on its inner circumference a holding surface 13a which holds an outer circumference portion 14a of the multipolar magnet 14. As shown in FIG. 1, the holding surface 13a is configured to include a diameter expanding surface 13b which extends from the circumference end of the contact portion 12b to the opposite side of the attachment portion 12a in the axial direction (right side in the figure) and in the diameter expanding direction, a cylindrical surface 13c which extends from the outer circumference end of the diameter expanding surface 13b to the right side in the axial direction, and a diameter reducing surface 13d which extends from the end of the cylindrical surface 13c to the right side in the axial direction and in the diameter reducing direction. In this embodiment, the diameter expanding surface 13b and the diameter reducing surface 13d each have a tapered shape. Furthermore, the outer circumference 14b of the disc-like multipolar magnet 14 has a surface shape following the holding surface 13a of the securing portion 13.

The base metal 11, which comprises the attachment portion 12a, the contact portion 12b, and the securing portion 13, can be integrally formed by, for example, press working. In this case, the cylindrical surface 13c and the diameter reducing surface 13d which have a predetermined width in the axial direction are formed in such a manner that a portion where the cylindrical surface 13c of the securing portion 13 is formed in the inner circumference is subjected to press molding so that it is longer than a predetermined length in the axial direction by a length of the diameter reducing surface 13d to be formed in the inner circumference, and then a portion corresponding to the diameter reducing surface 13d is plastically deformed so as to fold it to the inner circumference side. Needless to say, the base metal 11 having the above shape may be formed only by one press working, for example, with a specific press mold. Alternatively, the base metal 11 may be formed in the above shape by another machining such as cutting.

As the material forming the base metal 11, magnetic material, specifically, ferromagnetic metal, for example, stainless steel which is magnetic material and has rust prevention is preferably used. In this embodiment, for example, ferrite-based stainless steel (Japanese Industrial Standard SUS430) is used.

The multipolar magnet 14 (compressed molded body 114) before sintering is attached to the base metal 11 having the configuration described above. Specifically, as shown in FIG. 3, the compressed molded body 114 is sintered with the end surface of the compressed molded body 114 coming in contact with the contact portion 12b of the base metal 11 (at a position denoted by a dashed line in the figure). As in the present embodiment, when samarium-iron based magnetic powder is used as the magnetic powder of the compressed molded body 114 and tin powder is used as the non-magnetic metal powder, the volume of the compressed molded body 114 after sintering is larger than that of the compressed molded body 114 before sintering. In other words, the compressed molded body 114 expands after sintering. Accordingly, an outer circumference portion 114a of the compressed molded body 114 is held by the holding surface 13a of the securing portion 13. In this embodiment, a portion of a circumference surface 114b of the compressed molded body 114 which faces the cylindrical surface 13c is held by the cylindrical surface 13c of the securing portion 13 in the radial direction. Furthermore, portions of the circumference surface 114b which face the diameter expanding surface 13b and the diameter reducing surface 13d, respectively, are held by the diameter expanding surface 13b and the diameter reducing surface 13d of the securing portion 13 in the axial direction. As such, the compressed molded body 114 is held and secured to the base metal 11.

According to this securing method, load to the sintered compact at securing can be adjusted with dimensional accuracy of the base metal 11 which is formed by, for example, press working, without caulking to secure. Accordingly, it allows accurate securing compared with securing by caulking, which is easy to cause uneven caulking amount. Furthermore, according to the securing method, sintering of the compressed molded body 114 and securing to the base metal 11 can be performed at the same time, thereby simplifying working process and reducing the cost.

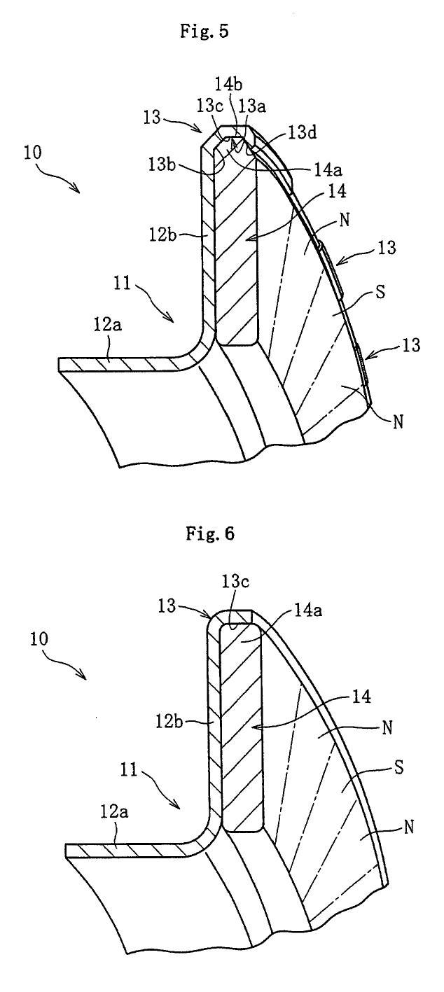

Note that the formation of the securing portion 13 of the base metal 11 is not limited to that described above, and may be another one. For example, FIG. 5 illustrates a formation in which the holding surface 13a is composed of the diameter expanding surface 13b, the diameter reducing surface 13d, and the cylindrical surface 13c, and a plurality of folding portions (portion where the diameter reducing surface 13d is formed in the inner circumference) to the inner circumference are formed at predetermined intervals in the circumferential direction.

For example, FIG. 6 shows a formation as still another structural example of the securing portion 13. In the figure, the holding surface 13a in the inner circumference of the securing portion 13 which consists only of the cylindrical surface 13c is illustrated. In this case, the compressed molded body 114 which comes in contact with the contact portion 12b expands after sintering, and thus is held by the cylindrical surface 13c in the radial direction. On the other hand, since the compressed molded body 114 is not bound in the axial direction, the compressed molded body 114 can expand with some degree of freedom in the opposite direction (the right direction in the figure) of the contact portion 12b. This prevents the compressed molded body 114 from receiving excessive load in the opposite direction of the expansion, caused by excessive expansion in the radial direction, from the cylindrical surface 13c, thereby ensuring the fixation of the sintered compact to the base metal 11 without breaking the sintered compact.

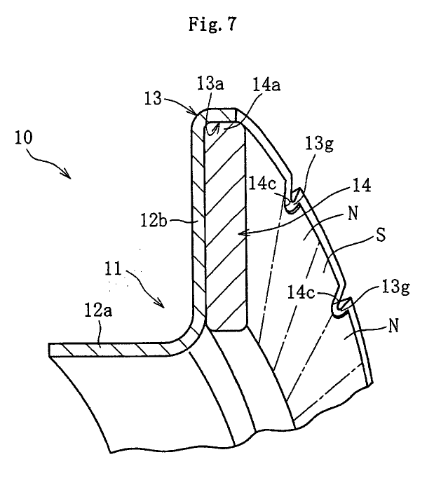

As shown in FIG. 7, the holding surface 13a of the securing portion 13 is partially deformed so as to project to the inner circumference side, and a projecting portion 13g and the compressed molded body 114 to be the sintered compact are engaged with each other in the circumferential direction, thereby being able to provide a rotation stopper of the compressed molded body 114. In this case, a recessed portion corresponding to the projecting portion 13g of the base metal 11 (corresponding to 14c in FIG. 7) is preformed on the compressed molded body 114, and the compressed molded body 114 is secured to the securing portion 13 by fitting the projecting portion 13g of the base metal 11 with the recessed portion at mounting on the base metal 11. In order to prevent rust, for example, a rust prevention coating, whose illustration is omitted, may be formed on the sintered compact. As this type of rust prevention coating, for example, a high anti-corrosion clear paint can be used.

As described above, the disc-like sintered compact, which is secured to the base metal 11 being a ring metal member, is magnetized with multipoles in the circumferential direction, and thus turned to the multipolar magnet 14. The magnetic encoder 10 shown in FIG. 1 is composed of the multipolar magnet 14 and the base metal 11.

This magnetic encoder 10 is attached in the rotor side member (not shown in figure), and is used for the rotation detection with a magnetic sensor 21 facing the multipolar magnet 14 as shown in FIG. 4. Thus, the magnetic encoder 10 constitutes a rotation detector 22 together with the magnetic sensor 21. The figure shows a structural example when the magnetic encoder 10 is used as a component of a seal device 5 of a bearing (not shown in figure), and the magnetic encoder 10 is built in the rotor side member of the bearing and used. The seal device 5 is composed of the magnetic encoder 10 and a seal member 9 in the stator side. A detailed configuration of the seal device 5 will be described later.

While the magnetic encoder 10 rotates, the passage of the respective magnetic poles N and S of the multipolar magnet 14 which are magnetized in multipole is detected by the magnetic sensor 21, so that its rotation is detected in the form of pulse. A pitch p (refer to FIG. 2) can be accurately set, for example, the accuracy of a pitch p of 1.5 mm and a pitch difference of ±3% can be set, thereby allowing high accurate rotation detection. The pitch difference is a value which indicates a ratio of a difference in distance between the magnetic poles detected at the positions separated by a predetermined position to a target pitch. When the magnetic encoder 10 is used in a seal device 5 for a bearing as shown in FIG. 4, the rotation of the bearing where the magnetic encoder 10 is attached is detected.

Note that the flatness of the surface (the opposite surface to the magnetic sensor 21 here) of the disc-like multipolar magnet 14 is preferably 200 μm or less, and desirably 100 μm or less. When the flatness of the surface of the multipolar magnet 14 exceeds 200 μm, a space (air gap) between the magnetic sensor 21 and the surface of the multipolar magnet 14 changes during rotation of the magnetic encoder 10, thereby deteriorating the sensing accuracy. For the same reason, the fluctuation of the surface of the multipolar magnet 14 is also preferably 200 μm or less, and desirably 100 μm or less, in the rotation of the magnetic encoder 10. In this embodiment, the compressed molded body 114 uniformly expands after sintering, thereby being able to easily place the flatness of the surface of the multipolar magnet 14 in the above range (200 μm or less). Furthermore, in this embodiment, in order to provide stable high sensing performances, the magnetic encoder 10 is configured so that the securing portion 13 does not project from the surface to be detected secured to the base metal 11 to the magnetic sensor 21 side, regardless of the shape of the securing portion 13 (FIGS. 1, 3 to 7).

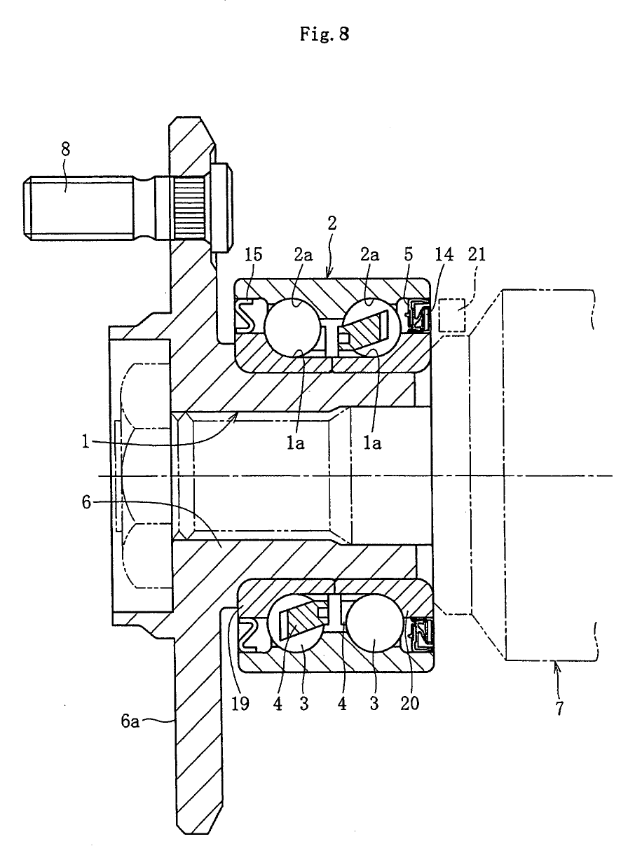

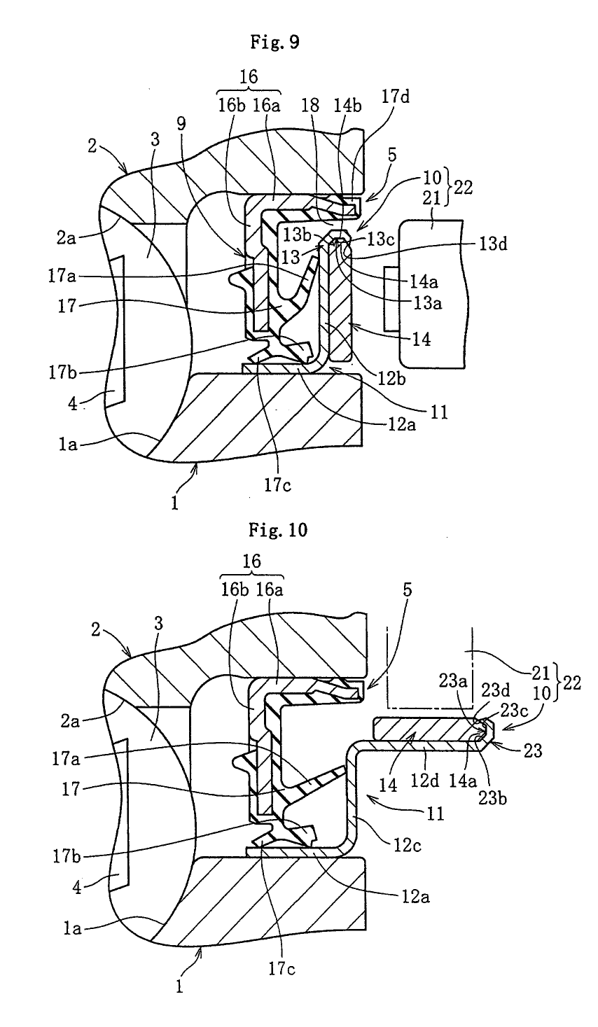

Next, one example of a wheel bearing provided with the magnetic encoder 10 and a structural example of the seal device 5 will be described, taking FIGS. 8 and 9 as an example. As shown in FIG. 8, the wheel bearing comprises an inner member 1, an outer member 2, a plurality of rolling elements 3 housed between the inner member 1 and the outer member 2, and seal devices 5 and 15 which seal up an end annular space between the inner member 1 and the outer member 2.

The seal device 5 in one end side (a constant velocity universal joint 7 side) includes the magnetic encoder 10 as a component. The inner member 1 and the outer member 2 have raceway surfaces 1a and 2a for the rolling element 3 each of which is formed in a groove-like shape. The inner member 1 and the outer member 2 are a member in the inner circumference side and a member in the outer circumference side, respectively, mutually rotatable through the rolling element 3, and may be just a bearing inner ring and just a bearing outer ring, respectively, or may be an assembly member in which the bearing inner ring and the bearing outer ring are combined with another member. The inner member 1 may be a shaft. The rolling element 3 is made from a ball or a roller, and the ball is used in this example.

This wheel bearing includes a plurality of rows of rolling bearings, specifically, a plurality of rows of angular ball bearings, and the bearing inner ring comprises a pair of divisional inner rings 19 and 20 which have the raceway surfaces 1a and 1a of the respective arrays of the rolling elements. The inner rings 19 and 20 are fit to the outer circumference of a shaft portion of a hub ring 6, and constitute the inner member 1 together with the hub ring 6. Note that the inner member 1 may include two parts of a hub ring with a raceway surface in which the hub ring 6 and one 19 of the inner rings are integrally formed and the other inner ring 20, instead of assembly parts composed of three parts of the hub ring 6 and the pair of divisional inner rings 19 and 20 as described above.

The hub ring 6 is connected to one end (for example, outer ring) of the constant velocity universal joint 7, and a wheel (not shown in figures) is attached to a flange portion 6a of the hub ring 6 via a bolt 8. The constant velocity universal joint 7 is connected to a drive shaft at another end (for example, inner ring). The outer member 2 comprises a bearing outer ring, and is attached to a housing (not shown in figures) comprising a knuckle and the like in a suspension system. The rolling elements 3 are retained for each row in a cage 4.

FIG. 9 is an enlarged cross-sectional view of the seal device 5 which integrally includes the magnetic encoder 10. This seal device 5 is the same as the one shown in FIG. 4, and its part has been already described, but its details will be described with reference to FIG. 9. In this seal device 5, the magnetic encoder 10 or the base metal 11 serves as a slinger, and is attached to the rotor side member among the inner member 1 and the outer member 2. In this example, since the rotor side member is the inner member 1, the magnetic encoder 10 is attached to the inner member 1 by means of press fit and the like.

The seal device 5 includes a first metal ring seal plate 11 and a second metal ring seal plate 16 which are attached to the inner member 1 and the outer member 2, respectively. The first seal plate 11 is equal to the base metal 11 in the magnetic encoder 10, and is hereinafter referred to as the base metal 11. The magnetic encoder 10 has the same configuration as the one based on FIGS. 1 to 3, and the same explanation is omitted. The magnetic sensor 21 is placed so as to face the multipolar magnet 14 in the magnetic encoder 10, so that the rotation detector 22 for detecting a wheel rotation speed is configured. Needless to say, the structure based on FIGS. 5 to 7 may be used as the magnetic encoder 10.

The second seal plate 16 is a member that composes the seal member 9 (refer to FIG. 4), and includes a side lip 17a which slidably contacts with the contact portion 12b of the base metal 11 serving as the first seal plate, and radial lips 17b and 17c which slidably contact with the attachment portion 12a, together. The seal lips 17a to 17c are provided as portions of an elastic member 17 which is adhered to the second seal plate 16 by cure. Any number of the lips 17a to 17c may be provided but one side lip 17a and two radial lips 17b and 17c located inside and outside in the axial direction (so-called, triple lip) are provided in the example of FIG. 9. The second seal plate 16 holds the elastic member 17 in an engagement portion with the outer member 2 serving as the stator member. In other words, the elastic member 17 includes a cover portion 17d which covers from the inner circumference surface of a cylindrical portion 16a to the top portion of the outer circumference, and the cover portion 17d is located in the engagement portion between the second seal plate 16 and the outer member 2. Furthermore, the cylindrical portion 16a of the second seal plate 16 and the securing portion 13 (portion where the cylindrical surface 13c is formed in FIG. 9) of the base metal 11 serving as the first seal plate face each other through a small space in the radial direction, by the cover portion 17d, and the space forms a labyrinth seal 18.

According to the wheel bearing having this structure, the rotation of the inner member 1 which rotates together with a wheel is detected by the magnetic sensor 21 through the magnetic encoder 10 attached to the inner member 1, and thus the rotational speed of the wheel is detected. The magnetic encoder 10 can detect the rotation of the wheel without increasing the number of components because it is employed as a component of the seal device 5. A space at the berating end in the wheel bearing is a narrow limited space because there are the constant velocity universal joint 7 and a bearing supporting member (not shown in figures) therearound. However, the multipolar magnet 14 of the magnet encoder 10 is configured to have high strength and thus can be formed thin, thereby facilitating the arrangement of the rotation detector 2. Sealing between the inner member 1 and the outer member 2 is implemented by slidably contacting the seal lips 17a to 17c which are provided in the second seal plate 16 and by the labyrinth seal 18 which is formed so that the securing portion 13 of the base metal 11 serving as the first seal plate faces the cylindrical portion 16a of the second seal plate 16 through a small space in the radial direction.

In the wheel bearing shown in FIGS. 8 and 9, the multipolar magnet 14 of the magnetic encoder 10 is provided outward with respect to the bearing (facing the magnetic sensor 21 in the right side in the figures) as described above, but to the contrary, it may be provided inward with respect to the bearing (facing the magnetic sensor 21 in the left side in the figures). In this case, the base metal 11 is preferably made of a non-magnetic material.

Moreover, in the magnetic encoder 10, the multipolar magnet 14 is not limited to the one facing in the axial direction but may be provided so as to face in the radial direction, for example as shown in FIG. 10. This figure illustrates a structure in which a fringe portion 12c which extends from one end to the outer circumference side is provided at the attachment portion 12a of the base metal 11 serving as a slinger of the seal device 5, and a securing portion 23 which holds and secures the multipolar magnet 14 to the outer edge of the fringe portion 12c through the contact portion 12d, are provided. In this case, the multipolar magnet 14 is formed not in a disc-like shape but in a cylindrical shape, and held and secured by a holding surface 23a (diameter expanding surface 23b, cylindrical surface 23c, and diameter reducing surface 23d), with the inner circumference surface coming in contact with the contact portion 12d. Note that the magnetic sensor 21 is located so as to face the multipolar magnet 14 in the radial direction.

Note that the magnetic encoder 10 is described as it is employed as a component of the seal device 5 of a bearing in the above embodiments, but the magnetic encoder 10 in each embodiment is not limited to a component of the seal device 5 and can be used for rotation detection alone. For example, the magnetic encoder 10 in the embodiment shown in FIG. 1 may be provided in the bearing, separate from the seal device 5, but not shown in figures.

### EXAMPLE

In order to verify effectiveness of the present invention, press-fit tests were performed in which a magnetic encoder (conventional device) with a sintered compact formed by a convention method and magnetic encoders (embodiment device 1 and embodiment device 2) with a multipolar magnet (sintered compact) formed by the method according to the present invention were each subjected to press fit on to a bearing inner ring (corresponding to the inner member 1 shown in FIG. 8), and the results were compared.

In this instance, a material composition and molding (sintering) conditions of the sintered compact of the comparative device were as follows:

Magnetic powder; samarium-iron based magnetic powder

Non-magnetic metal powder; tin powder (with a maximum grain size of 63 μm, and an apparent density of 2.27 g/cm³, and formed by the gas atomization method)

Mixture ratio; magnetic powder: non-magnetic metal powder=55 wt %: 45 wt %

Molding density; 6.4 g/cm³

Sintering temperature; 220° C., maintaining for 1 hr

A material composition and molding (sintering) conditions of the sintered compact of the embodiment device 1 were as follows:

Magnetic powder; samarium-iron based magnetic powder

Non-magnetic metal powder; tin powder (with 350 mesh under, and an apparent density of 2.14 g/cm³, and formed by the water atomization method)

Mixture ratio; samarium-iron based magnetic powder: tin powder=70 wt %: 30 wt %

Molding density; 6.6 g/cm³

Sintering temperature; 220° C., maintaining for 1 hr

A material composition and molding (sintering) conditions of the sintered compact of the embodiment device 2 were as follows:

Magnetic powder; samarium-iron based magnetic powder

Non-magnetic metal powder; tin-zinc alloy powder (with 75 wt % tin: 25 wt % zinc, a maximum grain size of 45 μm, and an apparent density of 1.76 g/cm³, and formed by the water atomization method)

Mixture ratio; samarium-iron based magnetic powder: tin-zinc alloy powder=60 wt %: 40 wt %

Molding density; 6.4 g/cm³

Sintering temperature; 180° C., 1 hr keeping

Note that 0.8 wt % zinc stearate were added both to the comparative device and the embodiment devices as a lubricant.

FIG. 13 shows results of the press-fit tests. As seen from the figure, while the comparative device has increased cracking probability when press-fit interferences are more than a predetermined value (130 μm), the embodiment devices 1 and 2 have high resistance to cracking regardless of the values of the press-fit interferences.

1. A magnetic encoder comprising a multipolar magnet prepared by subjecting a mixed powder of magnetic powder and non-magnetic metal powder to compression molding and then be sintered, the magnetic encoder characterized in that the multipolar magnet is composed of 20 to 90 wt % of the magnetic powder and 10 to 80 wt % of the non-magnetic metal powder, and is sintered at a temperature less than a melting point of the non-magnetic metal powder.

2. A magnetic encoder according to claim 1, wherein the non-magnetic metal powder has a maximum grain size of 63 μm or less.

3. A magnetic encoder according to claim 1, wherein the non-magnetic metal powder has a shape selected from the group consisting of a spongy shape, an acicular shape, an angular shape, a dendritic shape, a fibrous shape, a flake shape, an irregular shape, and a teardrop shape.

4. A magnetic encoder according to claim 3, wherein the non-magnetic metal powder is molded by a water atomization method or an oil atomization method.

5. A magnetic encoder according to claim 1, wherein the magnetic powder is samarium-iron based magnetic powder.

6. A magnetic encoder according to claim 1, wherein the non-magnetic metal powder is tin or a tin-zinc alloy.

7. A wheel bearing provided with a magnetic encoder according to claim 1.

8. A wheel bearing provided with a magnetic encoder according to claim 2.

9. A wheel bearing provided with a magnetic encoder according to claim 3.

10. A wheel bearing provided with a magnetic encoder according to claim 4.

11. A wheel bearing provided with a magnetic encoder according to claim 5.

12. A wheel bearing provided with a magnetic encoder according to claim 6.
